(19) United States
(12) Patent Application Publication
(10) Pub. No.: US 2010/0238094 A1
(43) Pub. Date: Sep. 23, 2010

(54) ESD PROTECTION CIRCUIT AND ORGANIC LIGHT EMITTING DISPLAY DEVICE HAVING THE SAME

(76) Inventors: Bong-Eun Cho, Yongin-city (KR); Won-Kyu Kwak, Yongin-city (KR)

Correspondence Address: CHRISTIE, PARKER & HALE, LLP, PO BOX 7068, PASADENA, CA, 91109-7068, US

(21) Appl. No.: 12/694,250

(22) Filed: Jan. 26, 2010

(30) Foreign Application Priority Data
Mar. 23, 2009 (KR) 1020090024346

(51) Int. Cl. G09G 3/30; H02H 9/04

(52) U.S. Cl. 345/82; 361/56

(57) ABSTRACT

An organic light emitting display device having an electrostatic discharge (ESD) protection circuit. The organic light emitting display device according to an embodiment of the present invention includes: a display panel; a plurality of signal input lines for transferring driving power and driving signals received from a pad unit at one side of the display panel to the inside of the display panel; and an ESD protection circuit coupled to one or more of the signal input lines. The ESD protection circuit includes at least one transistor having a gate electrode, a first electrode, and a second electrode, the gate electrode being diode-coupled to the first electrode. A distance from the gate electrode to the first electrode of the transistor and a distance from the gate electrode to the second electrode are different from each other.

### CROSS-REFERENCE TO RELATED APPLICATIONS

This application claims priority to and the benefit of Korean Patent Application No. 10-2009-0024346, filed on Mar. 23, 2009, in the Korean Intellectual Property Office, the entire content of which is incorporated herein by reference.

### BACKGROUND

1. Field of the Invention

The present invention relates to an electrostatic discharge (ESD) protection circuit and an organic light emitting display device having the same.

2. Discussion of Related Art

In general, a display panel of an organic light emitting display device is driven by receiving driving power and driving signals transferred from the outside of the display panel such as from a printed circuit board, etc.

To this end, a pad unit that includes a plurality of pads for receiving the driving power and the driving signals is formed on one side of the display panel. The pads are connected to a plurality of signal input lines so that the received driving power and driving signal can be transferred to the inside of the display panel.

The signal input lines, which are provided to transfer the driving power and driving signals from the pad unit to the inside of the display panel, are formed on the display panel in order to connect the pad unit and the components inside the display panel. For example, the signal input lines may be connected between the components inside the display panel, such as a display unit, a scan driver, and a data driver, etc., and the pad unit.

However, the signal input lines may be applied with not only the driving power and/or the driving signals but also unintended ESD. In this case, the ESD is transferred to the inside of the display panel through the signal input lines so that it may cause a driving defect or problem of the organic light emitting display device.

In order to prevent this, an ESD protection circuit can be connected to the input sides of the signal input lines. Such an ESD protection circuit includes a protection diode, etc. and prevents static electricity from being introduced into the display unit and the driving circuit unit, etc. inside the display panel.

However, when static electricity having a voltage with a large magnitude (that is, absolute value of the voltage) is introduced, the ESD protection circuit itself is damaged so that it may not protect the components inside the panel from static electricity.

### SUMMARY OF THE INVENTION

It is an aspect of embodiments of the present invention to provide an electrostatic discharge (ESD) protection circuit with improved durability against static electricity, and an organic light emitting display device including the same.

According to an embodiment of the present invention, there is provided an organic light emitting display device including: a display panel; a pad unit positioned at the display panel and includes a plurality of pads receiving driving power and driving signals from the outside of the display panel; a plurality of signal input lines for transferring the driving power and the driving signals received from the pad unit to the inside of the display panel; and an electrostatic discharge (ESD) protection circuit coupled to one or more of the signal input lines, wherein the ESD protection circuit includes at least one transistor having a gate electrode, a first electrode, and a second electrode, the gate electrode being diode-coupled to the first electrode, and wherein a distance from the gate electrode to the first electrode of the transistor and a distance from the gate electrode to the second electrode are different from each other.

Here, the distance from the gate electrode to the second electrode of the transistor may be larger than the distance from the gate electrode to the first electrode. Also, the distance from the gate electrode to the second electrode of the transistor may be 6 μm or more.

Also, the display panel may include a display unit including a plurality of pixels positioned at the crossing regions between scan lines and data lines, and a driving circuit for supplying driving signals to the pixels, and the ESD protection circuit may be coupled to one or more of the signal input lines that are coupled between the pad unit and at least one of the display unit and/or the driving circuit.

Also, the transistors may be diode-coupled in a reverse direction with respect to the driving power.

Also, the ESD protection circuit may include a first transistor that is diode-coupled between at least one signal input line of the signal input lines and a first power supply in a reverse direction with respect to the first power supply and a second transistor that is diode-coupled between the at least one signal input line and a second power supply in a reverse direction with respect to the second power supply.

According to another embodiment of the present invention, there is provided an electrostatic discharge (ESD) protection circuit coupled to an input side of a signal line, including: at least one transistor having a gate electrode, a first electrode, and a second electrode, the gate electrode being diode-coupled to the first electrode, wherein a distance from the gate electrode to the first electrode of the transistor and a distance from the gate electrode to the second electrode are different from each other.

Here, the distance from the gate electrode to the second electrode of the transistor may be larger than the distance from the gate electrode to the first electrode.

Also, the transistors may be diode-coupled in a reverse direction with respect to a power supply coupled to the signal line.

According to another embodiment of the present invention, there is provided an organic light emitting display device including: a display panel; a pad unit positioned at the display panel and including a plurality of pads for receiving driving power and driving signals from the outside of the display panel; a plurality of signal input lines for transferring the driving power and the driving signals received from the pad unit to the inside of the display panel; and at least one diode-coupled transistor coupled to one of the signal input lines in series with a power supply. A distance from a gate electrode to a first electrode of the at least one transistor and a distance from the gate electrode to a second electrode of the at least one transistor are different from each other.

With the embodiments of the present invention as described above, the durability of the ESD protection circuit against static electricity can be improved.

### BRIEF DESCRIPTION OF THE DRAWINGS

These and/or other aspects and features of the invention will become apparent and more readily appreciated from the following description of the exemplary embodiments, taken in conjunction with the accompanying drawings of which:

FIG. 1 is a schematic plan view of a display panel of an organic light emitting display device according to an embodiment of the present invention;

FIG. 2 is a schematic circuit view showing one example of an ESD protection circuit of FIG. 1;

FIG. 3 is a schematic circuit view showing another example of the ESD protection circuit of FIG. 1;

FIG. 4 is a schematic plan view of a principal part showing one example of a protection diode of FIG. 3; and

FIG. 5 is a schematic cross sectional view of a principal part showing another example of the protection diode of FIG. 3.

### DETAILED DESCRIPTION OF EXEMPLARY EMBODIMENTS

In the following detailed description, only certain exemplary embodiments of the present invention have been shown and described, simply by way of illustration.

As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” or “coupled to” another element, it can be directly connected to the another element or be indirectly connected to the another element with one or more intervening elements interposed therebetween. Hereinafter, like reference numerals refer to like elements.

Hereinafter, exemplary embodiments according to the present invention will be described with reference to the accompanying drawings.

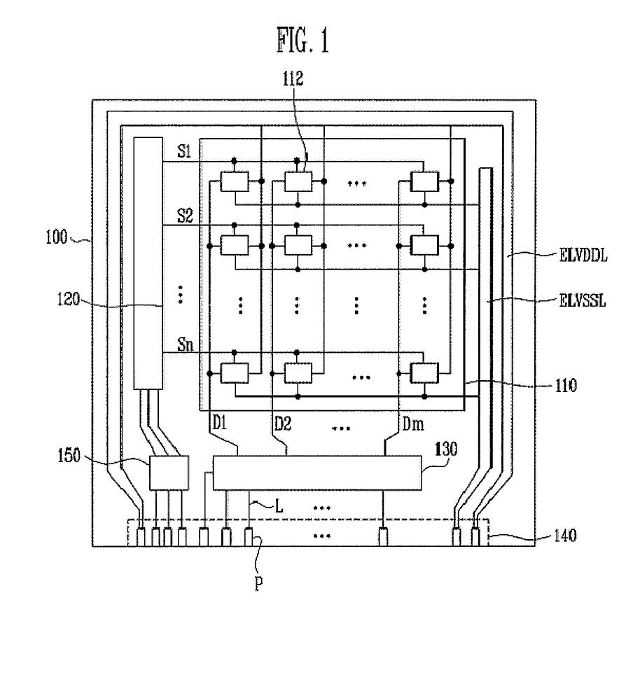

FIG. 1 is a schematic plan view of a display panel of an organic light emitting display device according to an embodiment of the present invention.

Referring to FIG. 1, the display panel 100 of the organic light emitting display device according to one embodiment of the present invention includes a display unit 110, and a driving circuit unit that includes a scan driver 120 and a data driver 130 that supply driving signals such as scan signals and data signals, respectively, to the display unit 110.

The display unit 110 includes a plurality of pixels 112 positioned at the crossing regions of scan lines S1 to Sn and data lines D1 to Dm. The display unit 110 displays an image corresponding to the scan signals and the data signals supplied from the scan lines S1 to Sn and the data lines D1 to Dm, respectively. Reference numerals ELVDDL and ELVSSL refer to supply lines of first and second pixel powers ELVDD and ELVSS, respectively.

The scan driver 120 generates the scan signals corresponding to scan driving power and scan control signals transferred from the pad unit 140. The scan signals generated by the scan driver 120 are supplied sequentially to the display unit 110 through the scan lines S1 to Sn.

The data driver 130 generates the data signals corresponding to data and data control signals transferred from the pad unit 140. The data signals generated by the data driver 130 are synchronized with the scan signals to be supplied to the display unit 110 through the data lines D1 to Dm.

The pad unit 140 is formed to be positioned on one side of the display panel 100 and has a plurality of pads P that receive driving power and driving signals from the external of the display panel 100.

Here, the pad unit 140 is connected to a plurality of signal input lines L so that the driving power and the driving signals input from the external of the display panel 100 can be transferred to the inside of the display panel 100. In other words, the respective pads P are connected to the components that are inside the display panel 100 through the respective signal input lines L. For example, the respective pads P may be connected to the display unit 110 or the driving circuit unit, etc. inside the display panel 100 through the respective signal input lines L.

The signal input lines L are formed on the display panel 100 in order to be connected between the pad unit 140 and the components that are inside the display panel 100 and thus, transfer the driving power and driving signals from the pad unit 140 to the inside of the display panel 100. For example, the signal input lines L are coupled between the display unit 110, the scan driver 120, and the data driver 130, and the pad unit 140, making it possible to transfer the driving power and the driving signals from the pad unit 140 to the display unit 110, the scan driver 120, and the data driver 130.

However, in the embodiments of the present invention, an electrostatic discharge (ESD) protection circuit 150 is coupled to an input side of at least one signal input line of the signal input lines L. In other words, the ESD protection circuit 150 is coupled to one or more signal input lines of the signal input lines L that are coupled between at least any one of the display unit 110 and driving circuit unit, and the pad unit 140.

For example, the ESD protection circuit 150 can be coupled to the signal input lines L that are coupled between the scan driver 120 and the pad unit 140 as shown in FIG. 1. In this embodiment, the ESD protection circuit 150 can be coupled to the signal input lines L of the scan driving power and/or scan control signals (for example, start pulse, clock signals, and output enable signals, etc. of the scan driver 120).

The ESD protection circuit 150 may include a protection diode that is coupled to at least one signal input line L, etc.

Thereby, the ESD introduced through the signal input line L is removed by the protection diode, preventing or reducing a driving defect or problem of the organic light emitting display device due to static electricity.

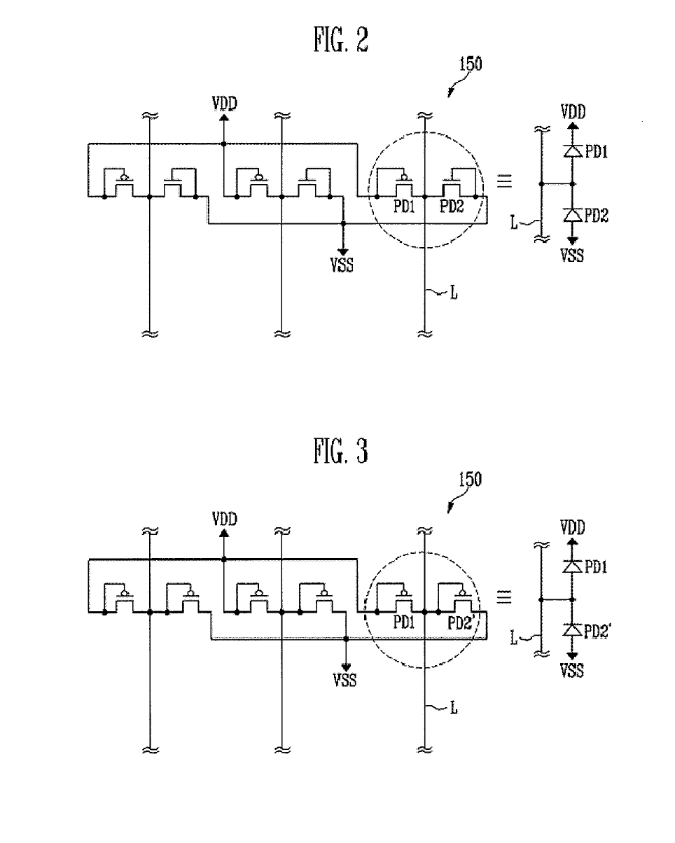

FIG. 2 is a schematic circuit view showing one embodiment of the ESD protection circuit of FIG. 1, and FIG. 3 is a schematic circuit view showing another embodiment of the ESD protection circuit of FIG. 1.

Referring to FIGS. 2 and 3, the ESD protection circuit 150 includes protection diodes PD (e.g., PD1 and PD2) that are coupled to each of at least one signal input lines L that couple the components inside the display panel to the pad unit 140.

For example, the ESD protection circuit 150 may include protection diodes PD that are coupled electrically to at least one signal input lines L that couple the pad unit 140 to at least any one of the display unit 110, the scan driver 120, and the data driver 130.

Here, the protection diodes PD may include a transistor that includes a gate electrode, a first electrode, and a second electrode, wherein the gate electrode is coupled to the first electrode to be diode-coupled, in particular, a transistor that is diode-coupled in a reverse direction with respect to a driving power supply. Also, as first and second power supplies that drive the protection diodes PD, a first scan driving power supply VDD that is a high-potential driving power supply, a second scan driving power supply VSS that is a low-potential driving power supply, or a separate power supply may be used.

For example, the ESD protection circuit 150 may include a first protection diode PD1 that is implemented as a first transistor that is diode-coupled between the signal input line L and the first power supply VDD in a reverse direction, and a second protection diode PD2 or PD2′ that is implemented as a second transistor that is diode-coupled between the signal input line L and the second power supply VSS in a reverse direction.

However, the description of the diode-coupling in the reverse direction is based on a general state of the signal input line L, that is, the case where the driving power and the driving signals, etc. are input. When positive static electricity or negative static electricity having large absolute value is input, the diode-coupling direction may also be described as in a forward direction with respect to the static electricity.

In other words, positive (+) static electricity having a voltage with a large magnitude (that is, absolute value of the voltage) is induced into the first power supply VDD, and negative (−) static electricity is induced into the second power supply VSS so that the static electricity is not input to other components formed inside the display panel.

For the convenience of manufacturing, the protection diode as described above may be formed simultaneously or concurrently with the semiconductor layer and the source/drain electrodes of the transistor included in the pixel, using the same material as the semiconductor layer and the source/drain electrodes.

In addition, the transistors used as the first and second protection diodes PD may be formed of transistors in different types as shown in FIG. 2, for example, P-type and N-type transistors, or may be formed of transistors in the same type as shown in FIG. 3, for example, P-type transistor, so that they may be variously modified. Also, although not shown, the ESD protection circuit 150 may further include a resistive element, etc.

As aforementioned, if the ESD protection circuit 150 that includes at least the protection diodes PD is formed on the signal input lines L that couple the components formed inside the display panel to the pad unit 140, the static electricity introduced to the signal input lines L from the external is bypassed toward the first power supply VDD or the second power supply VSS by the protection diodes PD. Therefore, the embodiments of the present invention prevent or reduce damage to the components inside the display panel due to the static electricity, making it possible to prevent or reduce the driving defect or problem of the organic light emitting display device.

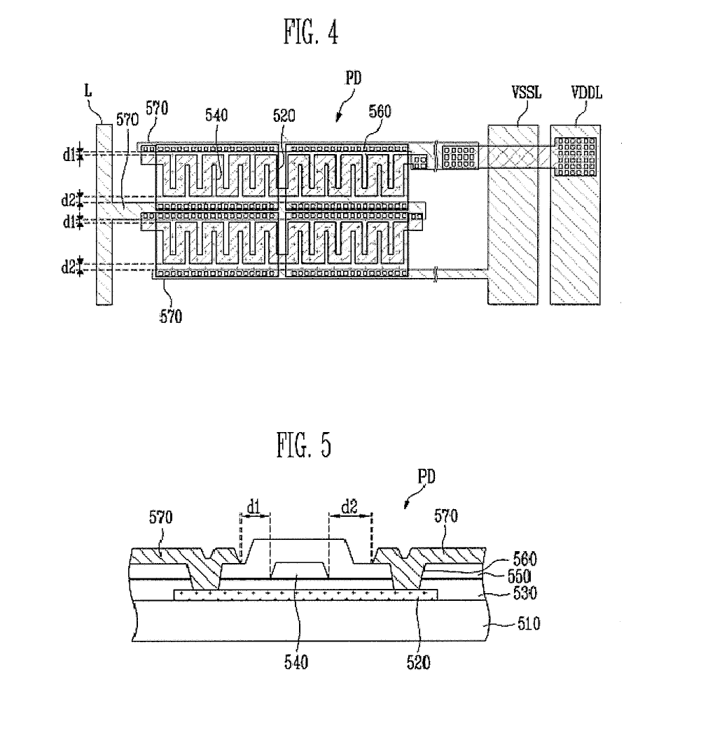

FIG. 4 is a schematic plan view of a principal part showing one embodiment of the protection diode of FIG. 3, and FIG. 5 is a schematic cross sectional view of a principal part showing another embodiment of the protection diode of FIG. 3. For convenience, FIG. 4 shows the first and second protection diodes coupled to one signal input line, and FIG. 5 schematically shows only one diode.

Referring to FIGS. 4 and 5, the protection diodes PD are formed between the signal input line L and the input line of the first power supply (hereinafter, referred to as VDDL), and between the signal input line L and the input line of the second power supply (hereinafter, referred to as VSSL), respectively.

More specifically, the protection diodes PD includes the first transistor that is diode-coupled between the signal input line L and the VDDL in a reverse direction with respect to a current flowing from the VDDL (it may be a forward direction when positive static electricity is input), and the second transistor that is diode-coupled between the signal input line L and the VSSL in a reverse direction with respect to a current flowing from the VSSL (it may be a forward direction when negative static electricity is input).

Here, the signal input line L, the VDDL, the VSSL, and the source and drain electrodes 570 may be made using the same material in the same process step. In this case, the source or drain electrode 570 of the respective transistors that constitute the protection diodes PD may be formed integrally with a conductive film that constitutes the signal input line L.

Also, the gate electrode 540 may be formed using the same material as a coupling wire that couples the VDDL to the first electrode of the first transistor in the same process step.

In addition, the semiconductor layer 520 is coupled between the source electrode 570 and drain electrode 570 of the respective transistors through contact holes 560.

The protection diodes PD as described above induce the static electricity input through the input signal line L toward a reference power supply such as the first or second power supply VDD or VSS to serve to protect other circuit elements from the static electricity.

Reviewing the cross-section of the protection diode PD with reference to FIG. 5, the protection diode PD is constituted by a transistor that includes a semiconductor layer 520 formed on a substrate 510, a gate insulating film 530 formed on the semiconductor layer 520, a gate electrode 540 formed on the gate insulating film 530, and source and drain electrodes 570 formed on an interlayer insulating film 550 and coupled to the semiconductor layer 520 through contact holes 560. Here, although not shown in FIG. 5, the gate electrode 540 of the transistor is coupled to the source or drain electrode 570 to be diode-coupled.

However, in embodiments of the present invention, as shown in FIGS. 4 and 5, the distance d1 between the gate electrode 540 and the first electrode (for example, the source electrode) of the transistor and the distance d2 between the gate electrode 540 and the second electrode (for example, the drain electrode) are set to be different from each other.

In particular, the second electrode that has a potential different from the potential of the gate electrode 540 is exemplarily formed to be further spaced from the gate electrode 540 compared to the first electrode that has the same potential as that of the gate electrode 540. In other words, in an embodiment of the present invention, since the distance d2 between the gate electrode 540 and the second electrode of the transistor is set to be larger than the distance d1 between the gate electrode 540 and the first electrode, the distance d2 is sufficiently large so that a short defect due to static electricity can be prevented or reduced.

For example, when the distance d1 between the gate electrode 540 and the first electrode of the transistor is set to 2 μm, the distance d2 between the gate electrode 540 and the second electrode of the transistor may be set to 6 μm or more. Here, the spaced distance d2 between the gate electrode 540 and the second electrode is exemplarily set to be large, however, it is an exemplar that its upper limit is appropriately adjusted in consideration of providing sufficient spacing and design efficiency, etc.

As described above, if the second electrode that has the potential different from the potential of the gate electrode 540 is formed to be sufficiently spaced from the gate electrode 540, making it possible to prevent or reduce the short defect from being generated between the gate electrode 540 and the second electrode even in the case where strong static electricity is introduced.

Therefore, the durability of the ESD protection circuit 150 itself against the static electricity is reinforced, making it possible to effectively protect the display panel from the static electricity without damaging the ESD protection circuit 150.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display device comprising:
a display panel;
a pad unit positioned at the display panel and comprising a plurality of pads for receiving driving power and driving signals from the outside of the display panel;
a plurality of signal input lines for transferring the driving power and the driving signals received from the pad unit to the inside of the display panel; and
an electrostatic discharge (ESD) protection circuit coupled to one or more of the signal input lines,
wherein the ESD protection circuit comprises at least one transistor having a gate electrode, a first electrode, and a second electrode, the gate electrode being diode-coupled to the first electrode, and
wherein a distance from the gate electrode to the first electrode of the transistor and a distance from the gate electrode to the second electrode are different from each other.

2. The organic light emitting display device as claimed in claim 1, wherein the distance from the gate electrode to the second electrode of the transistor is larger than the distance from the gate electrode to the first electrode.

3. The organic light emitting display device as claimed in claim 1, wherein the distance from the gate electrode to the second electrode of the transistor is 6 ᵤm or more.

4. The organic light emitting display device as claimed in claim 1, wherein the display panel comprises a display unit comprising a plurality of pixels positioned at the crossing regions between scan lines and data lines, and a driving circuit for supplying driving signals to the pixels.

5. The organic light emitting display device as claimed in claim 4, wherein the ESD protection circuit is coupled to one or more of the signal input lines that are coupled between the pad unit and at least one the display unit and the driving circuit.

6. The organic light emitting display device as claimed in claim 4, wherein the driving circuit comprises a scan driver for supplying scan signals to the scan lines and a data driver for supplying data signals to the data lines.

7. The organic light emitting display device as claimed in claim 1, wherein the at least one transistor is diode-coupled in a reverse direction with respect to the driving power.

8. The organic light emitting display device as claimed in claim 1, wherein the ESD protection circuit comprises a first transistor that is diode-coupled between at least one signal input line of the signal input lines and a first power supply in a reverse direction with respect to the first power supply and a second transistor that is diode-coupled between the at least one signal input line and a second power supply in a reverse direction with respect to the second power supply.

9. The organic light emitting display device as claimed in claim 8, wherein the first power supply has a driving voltage that is higher than that of the second power supply.

10. An electrostatic discharge (ESD) protection circuit coupled to an input side of a signal line, comprising:
at least one transistor having a gate electrode, a first electrode, and a second electrode, the gate electrode being diode-coupled to the first electrode,
wherein a distance from the gate electrode to the first electrode of the transistor and a distance from the gate electrode to the second electrode are different from each other.

11. The ESD protection circuit as claimed in claim 10, wherein the distance from the gate electrode to the second electrode of the transistor is larger than the distance from the gate electrode to the first electrode.

12. The ESD protection circuit as claimed in claim 10, wherein the distance from the gate electrode to the second electrode of the transistor is 6 ᵤm or more.

13. The ESD protection circuit as claimed in claim 10, wherein the at least one transistor is diode-coupled in a reverse direction with respect to a power supply coupled to the signal line.

14. The ESD protection circuit as claimed in claim 10, wherein the ESD protection circuit comprises a first transistor that is diode-coupled between the signal line and a first power supply in a reverse direction and a second transistor that is diode-coupled between the signal line and a second power supply in a reverse direction.

15. The ESD protection circuit as claimed in claim 10, wherein the first power supply has a driving voltage that is higher than that of the second power supply.

16. An organic light emitting display device comprising:
a display panel;
a pad unit positioned at the display panel and comprising a plurality of pads for receiving driving power and driving signals from the outside of the display panel;
a plurality of signal input lines for transferring the driving power and the driving signals received from the pad unit to the inside of the display panel; and
at least one diode-coupled transistor coupled to one of the signal input lines in series with a power supply,
wherein a distance from a gate electrode to a first electrode of the at least one transistor and a distance from the gate electrode to a second electrode of the at least one transistor are different from each other.

17. The organic light emitting display device as claimed in claim 16, wherein the distance from the gate electrode to the second electrode is larger than the distance from the gate electrode to the first electrode.

18. The ESD protection circuit as claimed in claim 16, wherein the distance from the gate electrode to the second electrode is 6 μm or more.
